(19) United States
(12) Patent Application Publication
(10) Pub. No.: US 2026/0030907 A1
(43) Pub. Date: Jan. 29, 2026

(54) Detection, Recognition, and Processing of Visual Features in Images

(71) Applicant: Google LLC, Mountain View, CA (US)

(72) Inventors: Huy Thong Nguyen, Mountain View, CA (US); Min-Chi Shih, Mountain View, CA (US); Evan Dorundo, Mountain View, CA (US); Shashank Chandrashekhar Shastry, Santa Clara, CA (US); Steven Weng-Kiang Tjiang, Palo Alto, CA (US)

(21) Appl. No.: 18/783,007

(22) Filed: Jul. 24, 2024

(51) Int. Cl. G06V 30/148; G01C 21/00; G06V 10/77; G06V 20/62

(52) U.S. Cl. CPC G06V 30/153; G01C 21/3804; G06V 10/77; G06V 20/62

(57) ABSTRACT

Methods, systems, devices, and non-transitory computer readable media for processing images and updating map data are provided. The disclosed technology can include receiving image data comprising a plurality of images. A plurality of attributes associated with the plurality of images can be determined based on inputting the image data into a machine-learned model that is configured to recognize one or more text segments detected in the plurality of images. The machine-learned model can comprise a plurality of task-specific heads configured to determine the plurality of attributes. One or more entities associated with the plurality of attributes can be determined. Furthermore, attribute data comprising the plurality of attributes associated with the one or more entities can be generated. Furthermore, based on the attribute data, map data associated with a plurality of locations can be updated.

### FIELD

The present disclosure relates generally to processing images and updating map data. More particularly, the present disclosure relates to the use of machine-learned models to detect or recognize features of images and generate attributes that correspond to the features of the images and can be used to update map data.

### BACKGROUND

The detection of objects in images may be used in a variety of different situations. In particular, information about the detected objects may be generated and stored in a database that indicates the types of objects that are present in the images. The database may then be accessed and searched in order to retrieve information about the associated images. However, the object detection performance of different applications can vary greatly and the task of verifying the accuracy of detected objects can be expensive, time consuming, and require a great deal of computing resources. As a result, the effectiveness of image detection and recognition tasks may depend on the type of computing hardware that is used as well as the types of object detection and recognition techniques that are used. Accordingly, there may be different approaches to processing images.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method of processing images. The computer-implemented method can comprise receiving, by a computing system comprising one or more processors, image data comprising a plurality of images. The computer-implemented method can comprise determining, by the computing system, based on inputting the image data into a machine-learned model configured to recognize one or more text segments detected in the plurality of images, a plurality of attributes associated with the plurality of images. The machine-learned model can comprise a plurality of task-specific heads configured to determine the plurality of attributes. The computer-implemented method can comprise determining, by the computing system, one or more entities associated with the plurality of attributes. The computer-implemented method can comprise generating, by the computing system, attribute data comprising the plurality of attributes associated with the one or more entities. Furthermore, the computer-implemented method can comprise updating, by the computing system, based on the attribute data, map data associated with a plurality of locations.

Another example aspect of the present disclosure is directed to one or more tangible non-transitory computer-readable media storing computer-readable instructions that when executed by one or more processors cause the one or more processors to perform operations. The operations can comprise receiving image data comprising a plurality of images. The operations can comprise determining, based on inputting the image data into a machine-learned model configured to recognize one or more text segments detected in the plurality of images, a plurality of attributes associated with the plurality of images. The machine-learned model can comprise a plurality of task-specific heads configured to determine the plurality of attributes. The operations can comprise determining one or more entities associated with the plurality of attributes. The operations can comprise generating attribute data comprising the plurality of attributes associated with the one or more entities. Furthermore, the operations can comprise updating, by the computing system, based on the attribute data, map data associated with a plurality of locations.

Another example aspect of the present disclosure is directed to a computing system comprising: one or more processors; one or more non-transitory computer-readable media storing instructions that when executed by the one or more processors cause the one or more processors to perform operations. The operations can comprise receiving image data comprising a plurality of images. The operations can comprise determining, based on inputting the image data into a machine-learned model configured to recognize one or more text segments detected in the plurality of images, a plurality of attributes associated with the plurality of images. The machine-learned model can comprise a plurality of task-specific heads configured to determine the plurality of attributes. The operations can comprise determining one or more entities associated with the plurality of attributes. The operations can comprise generating attribute data comprising the plurality of attributes associated with the one or more entities. Furthermore, the operations can comprise updating, by the computing system, based on the attribute data, map data associated with a plurality of locations.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that processes images according to example embodiments of the present disclosure;

FIG. 1B depicts a block diagram of an example computing device that processes images according to example embodiments of the present disclosure;

FIG. 1C depicts a block diagram of an example computing device that processes images according to example embodiments of the present disclosure;

FIG. 2 depicts a block diagram of examples of machine-learned models according to example embodiments of the present disclosure;

FIG. 3 depicts an example of a computing device according to example embodiments of the present disclosure;

FIG. 4 depicts an example of a machine-learned model according to example embodiments of the present disclosure;

FIG. 5 depicts an example of a computing system that generates attributes associated with images according to example embodiments of the present disclosure;

FIG. 6 depicts a flow chart diagram of an example method of processing images according to example embodiments of the present disclosure;

FIG. 7 depicts a flow chart diagram of an example method of generating map data based on a plurality of attributes according to example embodiments of the present disclosure;

FIG. 8 depicts a flow chart diagram of an example method of updating attributes according to example embodiments of the present disclosure; and

FIG. 9 depicts a flow chart diagram of an example method of training machine-learned models to process images according to example embodiments of the present disclosure.

Reference numerals that are repeated across plural figures are intended to identify the same features in various implementations.

### DETAILED DESCRIPTION

In general, the present disclosure is directed to generating attribute data based on the detection and/or recognition of features (e.g., visual features) in images. The attribute data can be associated with geographic locations and can be used to automatically update previously stored attributes associated with the geographic locations. The attribute data can be based on text in images that is recognized and associated with attributes of organizational entities including business entities. In particular, the disclosed technology can generate attribute data that comprises information such as the name, class (e.g., type of business), telephone number, and/or website associated with an entity associated with an image. Further, the disclosed technology can implement machine-learned models (e.g., joint embedding transformer models) that have been configured and/or trained to generate attribute data based on the recognition and/or classification of text segments detected in images.

For example, a computing system may receive a plurality of images. The plurality of images may comprise images of geographic locations that include buildings (e.g., store fronts). The image data can then be inputted into a machine-learned model, which can determine the plurality of attributes of the plurality of images. The machine-learned model can be configured to determine the plurality of attributes based on recognition and/or classification of one or more text segments detected in the plurality of images. For example, the machine-learned model may be configured and/or trained to detect and/or recognize text segments in images (e.g., text that is present in storefronts and signage associated with a business) and determine attributes such as business names, telephone numbers, and/or websites. The machine-learned model can comprise a multitask model that can comprise a plurality of task-specific heads that determine the plurality of attributes.

The disclosed technology can determine entities associated with the plurality of attributes. For example, the computing system can determine the attributes that are associated with a business entity. If the attributes of different entities are determined, the disclosed technology can determine which entities are associated with which attributes. The disclosed technology can then generate attribute data that comprises a plurality of attributes associated with one or more entities (e.g., an entity such as a business entity, non-profit organization, professional organization, or charitable organization). For example, the plurality of attributes can comprise a name of a business entity based on the detection and/or recognition of a business name on signage in an image.

The disclosed technology can then, based on the attribute data, update map data. The map data can comprise previously stored attributes that were generated before the attribute data. For example, the map data can comprise information associated with the name, telephone number, and website of a business that occupied a location one year before the time the attribute data was generated. Updating the map data can comprise the computing system accessing map data associated with a plurality of locations (e.g., map data indicating the businesses and residential addresses associated with a plurality of locations), determining the previously stored attributes associated with the plurality of locations that do not match the plurality of attributes of the attribute data, and/or replacing the previously stored attributes that do not match with the plurality of attributes of the attribute data. In some embodiments, in which pre-existing map data for some locations is not available, the disclosed technology can be used to generate map data (e.g., new map data) based on the plurality of attributes. For example, map data can be automatically generated for a newly developed area that was previously uninhabited.

The map data and/or attribute data can be used in a variety of applications including map and/or navigation applications. The ability to effectively generate attributes of images allows various types of data (e.g., map data) to be automatically updated. As such, the disclosed technology allows for improved processing of images such that attributes determined from images may be used in a variety of applications including as search applications, map applications (e.g., the attributes of a business entity can be shown in a map), and/or navigation applications.

Accordingly, the disclosed technology can generate improved attribute data that can be used to provide more comprehensive and/or more accurate information about entities (e.g., business entities) captured in images. Further, the disclosed technology can assist a user in more effectively and/or safely performing the technical task of image processing by means of a continued and/or guided human-machine interaction process in which images are received and the disclosed technology generates real-time business attributes based on continuously updated image data. For example, a user can use a smartphone to capture an image that is sent to a remote machine-learned model system that determines attributes from the image and sends the attributes back to the user's smartphone.

The disclosed technology can be implemented in a computing system (e.g., an image processing computing system) that is configured to access data and/or perform operations on the data. For example, the operations performed by the computing system can comprise receiving image data comprising images, determining, based on inputting the images into a machine-learned model, attributes of the images, determining entities associated with attributes, and/or generating attribute data comprising the attributes associated with the entities. Further, the computing system can leverage a machine-learned model that has been configured and/or trained to detect, recognize, and/or classify one or more text segments detected in images.

The computing system can be included as part of a system that includes a server computing device that receives data comprising images from a user's client computing device, performs operations based on the data and sends output comprising attribute data back to the client computing device. In some embodiments, the computing system can include specialized hardware and/or software that enables the performance of operations specific to the disclosed technology. For example, the computing system can include one or more application specific integrated circuits and/or neural processing units that are configured to perform operations associated with the recognition and/or classification of one or more text segments detected in images, determination of attributes determined from images, and/or the generation of attribute data comprising the attributes.

The computing system can receive, access, and/or retrieve image data comprising a plurality of images. For example, the plurality of images can comprise one or more color images, one or more grayscale images, and/or one or more black and white images). In some embodiments, the plurality of images can be formatted to have the same or similar resolution and/or color depth. In some embodiments, the plurality of images can include a plurality of points (e.g., pixels) that indicate visual information about a portion (e.g., x, y coordinates of a two-dimensional image or x, y, z coordinates of a three-dimensional image) of the plurality of images. Further, the plurality of images can comprise information associated with visual features of the plurality of images including spatial features associated with the spatial relationships between groups of the plurality of points (e.g., spatial relationships between lines and/or curves in an image). Further, the plurality of images can comprise information associated with a color space of the plurality of points (e.g., a hue, saturation, and/or brightness).

The plurality of images can be captured from one or more perspectives and/or one or more angles. For example, the plurality of images can be captured from perspectives comprising a front perspective, side perspective, or top-down perspective. Further, the plurality of images can be captured from angles comprising a high angle, a low angle, or an eye level angle. In some embodiments, the plurality of images can comprise one or more images of buildings captured from a perspective that is substantially parallel to a ground plane (e.g., within twenty-five degrees of a ground plane) of the plurality of images. For example, the plurality of images can comprise one or more images that capture the front of buildings comprising signage and/or storefronts.

The computing system can access one or more machine-learned models (e.g., a machine-learned model or a plurality of machine-learned models). The one or more machine-learned models can be configured and/or trained to generate and/or determine a plurality of attributes of the plurality of images based on detection, recognition, and/or classification of one or more text segments detected in the plurality of images.

The one or more text segments can comprise one or more symbols that can, individually and/or in combination with one or more other symbols, represent something (e.g., an object, an entity, a place, an event, and/or information associated with something). Further, the one or more text segments can comprise one or more letters, one or more numbers, one or more words, one or more punctuation marks, one or more sentences, and/or one or more groups of sentences (e.g., one or more paragraphs). For example, the one or more text segments can comprise a name (e.g., a name of an entity), a telephone number, a website, and/or a street address. In some embodiments, the one or more text segments can comprise pictograms, logographs, and/or ideograms.

The one or more machine-learned models can be configured and/or trained to perform one or more object detection operations to detect one or more objects in the plurality of images. For example, the one or more machine-learned models can detect one or more text segments (e.g., words on a sign and/or wall of a building) in the plurality of images. Further, the one or more machine-learned models can be configured and/or trained to perform one or more object recognition operations to recognize one or more objects in the plurality of images. For example, the one or more machine-learned models can recognize and/or identify one or more text segments (e.g., a telephone number on a billboard) in the plurality of images.

The one or more machine-learned models can generate one or more detection boxes around one or more text segments that are detected and/or recognized in the plurality of images. The one or more detection boxes can comprise a set of coordinates (x, y coordinates for two dimensional images or x, y, z coordinates for three dimensional images) that can indicate one or more portions of an image in which one or more text segments are detected. Further, the one or more machine-learned models can be configured and/or trained to determine and/or generate one or more confidence scores associated with the accuracy of the one or more text segments (e.g., a probability that the one or more text segments were accurately detected and/or recognized). For example, the one or more machine-learned models can determine and/or generate a confidence score ranging from 0.0 to 1.0, in which 0.0 represents the lowest accuracy and 1.0 represents the highest accuracy.

The one or more machine-learned models can be configured and/or trained to classify one or more objects and/or generate one or more attributes based on the classification of the one or more objects. For example, based on the detection and/or recognition of one or more text segments indicating a set of numbers that are the length of a telephone number and separated by hyphens, the one or more machine-learned models can classify the one or more text segments as a telephone number and generate a telephone number attribute based on the one or more text segments. Further, based on the detection and/or recognition of one or more text segments comprising the words “ROYAL CUISINE AND EATERY” the one or more machine-learned models can classify the one or more text segments as a restaurant and generate a category attribute indicating that a name attribute (“ROYAL CUISINE AND EATERY”) is categorized as a restaurant.

The one or more machine-learned models can be trained based on a plurality of images of geographic locations comprising one or more objects comprising buildings (e.g., residential houses, office buildings, apartment buildings, schools, hotels, restaurants, shopping centers, places of worship, warehouses, libraries, and/or factories), signage (e.g., billboards comprising electronic billboards, and/or posters), fencing (e.g., fencing comprising painted advertisements), and/or walls (e.g., walls comprising posters, signs, and/or painted advertisements).

The computing system can generate and/or determine a plurality of attributes. The plurality of attributes can be associated with one or more entities (e.g., an organizational entity). The plurality of attributes can be generated based on inputting the plurality of images into a machine-learned model. The machine-learned model can be configured and/or trained to detect and/or recognize one or more text segments in the plurality of images. Further, the machine-learned model can comprise a plurality of task-specific heads configured to generate and/or determine the plurality of attributes.

In some embodiments, the machine-learned model can comprise a multitask model. Further, the machine-learned model can comprise a main encoder and/or a plurality of task-specific heads. The main encoder can be configured and/or trained to generate a plurality of embeddings (e.g., a plurality of multimodal embeddings based on a plurality of multimodal inputs). In some embodiments, the main encoder can comprise a transformer (e.g., a joined transformer which can comprise a joined encoder). Further, the plurality of task-specific heads can be configured and/or trained to determine the plurality of attributes based on the plurality of embeddings generated by the main encoder.

The plurality of task-specific heads can be configured and/or trained to determine different attributes of the plurality of attributes (e.g., a first task specific head that determines name attributes, a second task specific head that determines telephone number attributes, and a third task specific head that determines website attributes). For example, the main encoder can generate the plurality of multimodality embeddings and the plurality of task specific heads can be configured and/or trained to generate the plurality of attributes (e.g., different attributes) based on the plurality of multimodality embeddings. The plurality of task-specific heads can comprise a task-specific entity name head that is configured and/or trained to generate or determine entity name attributes, a task-specific entity address head that is configured and/or trained to generate or determine an entity's address attributes, a task-specific an entity's website head that is configured and/or trained to generate or determine an entity's website attributes, a task-specific business classifier score head that is configured and/or trained to generate or determine a business classifier score associated with an entity, a task-specific global category identifier (GCID) head that is configured and/or trained to generate or determine a GCID associated with an entity, and/or a task-specific telephone number head that is configured and/or trained to generate or determine an entity's telephone number attributes. In some embodiments, one or more of the plurality of task-specific heads can be configured and/or trained to determine more than one attribute of the plurality of attributes.

In some embodiments, the plurality of task-specific heads can be associated with and/or comprise a plurality of encoders (e.g., task-specific heads comprising encoders that can be configured to generate embeddings), a plurality of decoders (e.g., task-specific heads comprising decoders that can be configured to generate and/or determine attributes based on an embedding), and/or a plurality of encoder-decoders (e.g., task-specific heads that can be configured to generate embeddings and/or determine or generate attributes based on an embedding).

In some embodiments, the plurality of task-specific heads can comprise an object encoder (e.g., an object encoder that is configured to generate a plurality of image embeddings that can be based on detecting or recognizing one or more objects in the plurality of images), a text encoder (e.g., a text encoder that is configured to generate a plurality of text embeddings that can be based on detecting or recognizing the one or more text segments in the plurality of images), and/or an optical character recognition (OCR) encoder (e.g., an OCR encoder that is configured to generate a plurality of OCR embeddings based on one or more text segments).

The plurality of attributes can comprise one or more names that can be associated with one or more entities (e.g., the name of a business entity), one or more classes (e.g., an organizational class associated with a type of organization) that can be associated with one or more entities (e.g., one or more classes comprising a business class, a non-profit class, an educational class, a residential class, or a commercial class), one or more categories that can be associated with one or more entities (e.g., one or more categories comprising a grocery store, pharmacy, car dealership, electronics store, jewelry store, or clothing boutique), a business classifier score that can be associated with one or more entities, a global category identifier (GCID) that can be associated with one or more entities, one or more telephone numbers that can be associated with one or more entities, one or more websites that can be associated with one or more entities, an operational status that can be associated with one or more entities (e.g., whether one or more entities is currently open, a payment attribute that can be associated with one or more entities (e.g., the types of credit or debit payments that are accepted), service options that can be associated with one or more entities (e.g., service options comprising dine-in service or delivery service for an eating establishment), operational hours that can be associated with one or more entities (e.g., the days of the week and/or times of day that one or more entities is open for business), and/or an address (e.g., a street address) associated with the entity.

Further, one or more of the plurality of attributes can be associated with one or more other attributes of the plurality of attributes. For example, the name of an entity can be associated with the telephone number and/or website of an entity. By way of further example, the name of an entity can be associated with a geographic location (e.g., a set of geographic coordinates) of an entity. In some embodiments, the plurality of attributes can comprise an entity attribute (e.g., an attribute that indicates the name of an organizational entity associated with other attributes of the plurality of attributes).

In some embodiments, the machine-learned model can be configured and/or trained to determine the plurality of attributes based on analysis of the plurality of text segments. For example, the machine-learned model can be configured and/or trained to determine that a segment of text ending in a top-level domain (e.g., “.COM” or “.ORG”) is associated with a website attribute. By way of further example, the machine-learned model can be configured and/or trained to determine that a segment of text comprising seven or ten digits is associated with a telephone number attribute. Further, the machine-learned model can be configured and/or trained to determine that a segment of text ending in “Street,” “Avenue,” “Road,” “St.,” or “Ave.,” is associated with an address attribute.

The machine-learned model can be configured to determine the plurality of attributes concurrently. For example, one or more attributes comprising a name, telephone number, and website that can be associated with an entity can be determined concurrently. Further, concurrently determining the plurality of attributes can comprise the machine-learned model performing operations in which the machine-learned model uses a plurality of detection and recognition operations to detect and/or recognize the visual features associated with text segments in the image.

The plurality of attributes can be based on the plurality of images and/or associated with one or more entities (e.g., a business entity). In some embodiments, the plurality of attributes can be based on the one or more text segments associated with one or more entities (e.g., business entity). For example, the machine-learned model can be configured and/or trained to determine the one or more text segments associated with a least one entity based on one or more characteristics comprising a size of the one or more text segments (e.g., larger text segments may have a higher probability of being associated with an entity), a location of the one or more text segments (e.g., text segments that are located on a door, window, or on top of a building may have a higher probability of being associated with the name of an entity).

The machine-learned model can comprise a transformer (e.g., a joined transformer) that is configured and/or trained to generate multimodal embeddings based on a plurality of multimodal inputs. The plurality of multimodal inputs can comprise a plurality of images, one or more text segments, one or more detection boxes associated with the one or more text segments, and/or one or more confidence scores associated with the one or more text segments. For example, the plurality of multimodal inputs can comprise an image of a storefront associated with a business entity, a text segment comprising a name of a business entity that is printed on a sign on the storefront, a detection box around the name of the business entity, and a confidence score of 0.98 on a scale of 0.0 to 1.0, which indicates a high probability that the text segment is accurate.

In some embodiments, the multimodality embeddings (e.g., the multimodality embeddings generated by the one or more machine-learned models which can comprise the transformer) can be used to determine the plurality of attributes. In some embodiments, the plurality of multimodal embeddings can be based on a plurality of image embeddings (e.g., a plurality of image embeddings based on the plurality of images), a plurality of text embeddings (e.g., text embeddings based on one or more text segments detected and/or recognized in the plurality of images), a plurality of optical character recognition (OCR) embeddings (e.g., OCR embeddings based on detection boxes and/or confidence scores associated with the plurality of images).

The plurality of image embeddings can be generated by an object encoder, the plurality of text embeddings can be generated by a text encoder, and/or the plurality of OCR embeddings can be generated by an OCR encoder. The one or more machine-learned models can then determine the plurality of attributes based on processing the embeddings (e.g., the image embeddings, text embeddings, and/or the OCR embeddings).

The machine-learned model can comprise an object encoder that is configured and/or trained to generate a plurality of image embeddings (e.g., a numerical representation of the visual features of an image) based on the plurality of images. Generating the plurality of image embeddings can be based in part on the machine-learning model detecting and/or recognizing one or more objects in the plurality of images. Further, generating the plurality of image embeddings can be based in part on the machine-learning model determining one or more spatial characteristics and/or one or more color characteristics of the plurality of images.

The machine-learned model can comprise a text encoder that is configured and/or trained to generate a plurality of text embeddings (e.g., a numerical representation of the text features of an image) based on the one or more text segments detected and/or recognized in the plurality of images. Generating the plurality of text embeddings can be based in part on the machine-learning model transcribing one or more text segments in the plurality of images.

The machine-learned model can comprise an optical character recognition (OCR) encoder that is configured and/or trained to generate a plurality of optical character recognition (OCR) embeddings based on the one or more text segments. The plurality of OCR embeddings can be associated with one or more detection boxes and/or one or more confidence scores. The one or more detection boxes can be associated with a region in an image that comprises one or more text segments. The one or more confidence scores can be associated with the accuracy of the detection and/or recognition of the one or more text segments.

The system can determine one or more entities associated with the plurality of attributes. For example, the computing system can determine at least one business entity that is associated with one or more attributes of the plurality of attributes. Determination of the one or more entities associated with the plurality of attributes can be based on an entity attribute generated and/or determined by the machine-learned model. For example, the entity attribute can be based on a name attribute that indicates the name of one or more entities (e.g., the name attribute can comprise the name of a business). Further, the entity attribute can indicate which of the plurality of attributes are associated with the one or more entities. For example, the entity attribute can indicate the address, telephone number, and/or website that are depicted in an image that are associated with an entity. If multiple addresses, telephone numbers, and/or website attributes are determined, the machine-learned model can determine which of the attributes are associated with the one or more entities. In some embodiments, the machine-learned model can determine that multiple attributes of the same type (e.g., two telephone number attributes) are associated with the same entity.

The determination of which of the plurality of attributes are associated with the one or more entities can be based on the distance between the plurality of text segments associated with the plurality of attributes. In some embodiments, the locations of the plurality of text segments can be based on the detection boxes associated with the plurality of text segments. For example, a plurality of text segments associated with a plurality of different attributes (e.g., a name, telephone number, and website) can be determined to be associated with the same entity if the plurality of text segments are within a threshold distance (e.g., the name, telephone number, and website can be listed one on top of the other with a small distance between them) of other text segments. Attributes associated with text segments that are far apart (e.g., a distance exceeding the threshold distance) may be determined not to be associated with the same entity. For example, a name and phone number that are on opposite sides of a building may not be determined to be associated with the same entity.

The determination of which of the plurality of attributes are associated with the one or more entities can be based on a size, shape, color, and/or design of the plurality of text segments associated with the plurality of attributes. For example, a plurality of text segments associated with a plurality of different attributes (e.g., a name, telephone number, and website) can be determined to be associated with the same entity if the plurality of text segments have the same font, font size, and/or color. In some embodiments, the machine-learned model can be configured and/or trained to compare the size, shape, color, and/or design of the plurality of text segments associated with the plurality of attributes and determine the plurality of attributes that are associated with an entity based on the similarity of the size, shape, color, and/or design of the plurality of text segments.

The computing system can generate attribute data. The attribute data can comprise the plurality of attributes. Further, the attribute data can comprise the plurality of attributes associated with the one or more entities (e.g., a business entity). For example, the attribute data can comprise the name attribute of a business entity based on text segments detected on an image of a billboard above a building, a telephone number attribute based on a text segment detected on an image of the telephone number of the business entity on the same billboard, and/or a website attribute based on a text segment detected on an image of the website of the business entity on the same billboard. Generating the attribute data can comprise the computing system determining which attributes of the plurality of attributes are associated with an entity. For example, the plurality of attributes can comprise an attribute that indicates the entity. Further, the attribute data can be generated in a format based on a type of application that will use the attribute data. For example, the attribute data can be formatted for inclusion in map data (e.g., map data used by a mapping application and/or navigation application).

The computing system can update map data. For example, updating the map data can comprise the computing system modifying, generating, replacing, and/or deleting one or more portions of the map data. For example, one or more previously stored attributes of the map data can be replaced with one or more of the plurality of attributes of the attribute data. The map data can be associated with a plurality of locations (e.g., geographic coordinates and/or addresses). For example, a portion of map data can indicate that an entity (e.g., a business) is located at a particular location (e.g., the address or latitude, longitude, and/or altitude associated with the entity's location). Further, the map data can comprise a plurality of previously stored attributes associated with the plurality of locations and/or generated before the plurality of attributes of the attribute data. For example, the map data can comprise a plurality of attributes that were generated six months before the attribute data was generated and which comprise the name, telephone number, and website of a business entity at a location of the plurality of locations.

In some embodiments, the map data can comprise and/or be associated with navigation data, routing data, geographic data, and/or location data. Further, the map data can be configured for use by map applications, navigation applications, routing applications, and/or mapping applications. For example, the map data can be used by a map application that is used to provide directions from one location indicated in the map data to one or more other locations indicated on the map data.

The map data can be updated based on the attribute data. Further, the computing system can access map data (e.g., locally stored map data and/or map data stored on a remote computing system), determine whether the previously stored attributes associated with the plurality of locations match the plurality of attributes of the attribute data (e.g., the plurality of attributes associated with the one or more entities), and/or update (e.g., modify and/or replace) the previously stored attributes that do not match the plurality of attributes of the attribute data based on the plurality of attributes of the attribute data. For example, if the previously stored attributes associated with a particular location comprise a website attribute that does not match the website attribute of the plurality of attributes of the attribute data for the same location, the previously stored website attribute can be deleted or stored as a historical attribute and replaced with the website attribute of the plurality of attributes of the attribute data.

The computing system can access a plurality of previously stored attributes. In some embodiments, the plurality of previously stored attributes can be associated with map data and/or stored as part of map data. In some embodiments, the computing system can access map data comprising the plurality of previously stored attributes which can be associated with the plurality of locations. The plurality of previously stored attributes can be generated before the plurality of attributes of the attribute data (e.g., the plurality of attributes associated with the one or more entities). For example, the previously stored attributes can be based on images captured at a first time interval that precedes a second time interval at which the plurality of images associated with the plurality of attributes of the attribute data were captured. In some embodiments, the plurality of previously stored attributes can comprise a plurality of time interval attributes indicating a plurality of time intervals at which the plurality of previously stored attributes were generated. Further, the plurality of attributes of the attribute data and/or the plurality of previously stored attributes can be associated with a plurality of locations. For example, the plurality of attributes of the attribute data and/or the plurality of previously stored attributes can be associated with a plurality of geographic locations (e.g., a set of geographic coordinates comprising a latitude, longitude, and/or altitude).

The computing system can determine, for each of the plurality of locations, the plurality of attributes of the attribute data that do not match the plurality of previously stored attributes. For example, the computing system can determine whether the plurality of attributes of the attribute data that are associated with a first location (e.g., a geographic location) do not match the plurality of previously stored attributes associated with the same first location. In some embodiments, the plurality of locations can comprise locations that are similar. The plurality of locations that are similar can comprise one or more locations in which a location associated with the plurality of attributes of the attribute data is the same as or within a threshold distance (e.g., within five to ten meters) of a location associated with the plurality of previously stored attributes. Further, the plurality of locations that are similar can comprise one or more locations in which an address (e.g., street address) associated with the plurality of attributes of the attribute data is the same as the address associated with the plurality of previously stored attributes.

In some embodiments, the computing system can determine, for each of the plurality of locations, the plurality of attributes of the attribute data that match the plurality of previously stored attributes. For example, the computing system can determine whether the plurality of attributes of the attribute data that are associated with a second location (e.g., an address) match the plurality of previously stored attributes associated with the same second location.

Further, determining, for each of the plurality of locations, the plurality of attributes of the attribute data that do not match the plurality of previously stored attributes can comprise comparing the plurality of attributes of the attribute data to the plurality of previously stored attributes and determining one or more differences between the plurality of attributes of the attribute data and the plurality of previously stored attributes based on the comparison. For example, the computing system can determine one or more differences based on comparing the plurality of attributes of the attribute data comprising the name and/or telephone number of an entity to the plurality of previously stored attributes comprising the name and/or telephone number of the entity that was previously stored.

The computing system can replace and/or modify, at each of the plurality of locations in which the plurality of attributes of the attribute data do not match the plurality of previously stored attributes, the plurality of previously stored attributes based on the plurality of attributes of the attribute data. For example, if the computing system determined that the previously stored address attribute of an entity indicated in the plurality of previously stored attributes associated with a location does not match the address attribute indicated in the plurality of attributes of the attribute data associated with the same location, the previously stored address attribute can be deleted and/or overwritten with the more recent address attribute of the attribute data

In some embodiments, computing system can replace and/or substitute, at each of the plurality of locations in which the plurality of attributes of the attribute data do not match the plurality of previously stored attributes, the plurality of previously stored attributes with the plurality of attributes of the attribute data. For example, if the computing system determined that the previously stored name attribute of an entity indicated in the plurality of previously stored attributes associated with a location does not match the name attribute indicated in the plurality of attributes of the attribute data associated with the same location, the previously stored name attribute can be replaced with the more recent name attribute of the attribute data. In some embodiments, the plurality of previously stored attributes and/or the plurality of attributes of the attribute data are associated with and/or part of map data. Further, replacing at each of the plurality of locations in which the plurality of attributes of the attribute data do not match the plurality of previously stored attributes, the plurality of previously stored attributes with the plurality of attributes of the attribute data can comprise replacing and/or updating the plurality of previously stored attributes in map data with the plurality of attributes (e.g., more up to date attributes) of the attribute data.

The computing system can determine a plurality of locations associated with the plurality of attributes. For example, the computing system can access location data associated with the plurality of images (e.g., latitude, longitude, and/or altitude location information included in metadata associated with the plurality of images) and/or access one or more location attributes that indicate a location associated with an image of the plurality of images (e.g., a street address based on detection of a street sign in an image).

The computing system can generate map data comprising the plurality of attributes and/or the plurality of locations (e.g., geographic locations) associated with the plurality of attributes. In some embodiments, one or more locations of the plurality of locations can be associated with one or more attributes of the plurality of attributes. For example, a location (e.g., a street address) can be associated with attributes comprising the name of an entity and/or the telephone number of an entity.

In some embodiments, the machine-learned model can be configured and/or trained to determine the plurality of attributes. Training the machine-learned model to determine the plurality of attributes can comprise receiving training data. The training data can comprise a plurality of training images and/or a corresponding plurality of ground-truth attributes. The ground-truth attributes can be based on visual features comprising text segments that are visible in the plurality of training images. For example, the plurality of training images can include a plurality of images of buildings associated with a corresponding plurality of ground-truth attributes that indicate attributes associated with the images including entity names, phone numbers, addresses, and/or websites that are visible within the plurality of images.

Further, training the machine-learned model can comprise determining, based on inputting the plurality of training images into the machine-learned model, a plurality of predicted attributes. Based on the received input, the machine-learned model can perform one or more operations and generate an output comprising a plurality of predicted attributes associated with the corresponding plurality of training images. The output of the machine-learned model can then be evaluated based on one or more comparisons of the plurality of predicted attributes to a corresponding plurality of ground-truth attributes associated with the plurality of training images.

Training the machine-learned model can comprise determining a loss based on one or more differences between the plurality of predicted attributes and the plurality of ground-truth attributes. For example, a loss function may be used to determine the loss. The loss function may be used to evaluate the one or more differences between the plurality of predicted attributes and the plurality of ground-truth attributes. The loss may increase in proportion to the number of the one or more differences between the plurality of predicted attributes and the plurality of ground-truth attributes. For example, if there are four differences between the plurality of predicted attributes and the plurality of ground-truth attributes, the loss can be greater than if there are two differences between the plurality of predicted attributes and the plurality of ground-truth attributes.

Further, the loss may increase in proportion to the magnitude of differences between the plurality of predicted attributes and the plurality of ground-truth attributes. For example, a predicted attribute that is slightly different from a ground-truth attribute (e.g., a single number in a predicted telephone number attribute being different from the ground-truth) may result in a greater loss than a predicted attribute that is very different from a ground-truth attribute (e.g., five numbers in a predicted telephone number attribute being different from the ground-truth attribute).

Training the machine-learned model can comprise modifying a plurality of parameters of the machine-learned model to minimize the loss. The plurality of parameters can be associated with detection and/or recognition of one or more features (e.g., visual features) and/or one or more text segments of the plurality of images and can be used to determine the predicted attributes. Further, the plurality of parameters can be associated with a plurality of weights that can be associated with an extent to which the plurality of parameters contribute to determining the loss.

Training the machine-learned model can be performed over a plurality of iterations. In each iteration of training, the weight of the plurality of parameters that contribute to increasing the loss can be reduced and/or the weight of the plurality of parameters that contribute to decreasing the loss can be increased. As a result, the plurality of weights of the plurality of parameter can be associated with the plurality of predicted attributes such that parameters that are more heavily weighted can contribute more to determining the predicted attributes than parameters that are less heavily weighted. Over the plurality of iterations, the weights of the plurality of parameters can be modified to minimize the loss until a threshold loss that corresponds to a high accuracy of the machine-learned model determining the plurality of predicted attributes is achieved. For example, the loss can be minimized until a threshold loss associated with 98% accuracy is achieved by the machine-learned model.

In some embodiments, the training data can comprise a plurality of training text segments based on optical character recognition (OCR) of the plurality of images, a plurality of training detection boxes associated with each of the plurality of training text segments, and/or a plurality of training confidence scores associated with each of the plurality of training text segments. The plurality of training detection boxes associated with each of the plurality of training text segments can indicate the portions of the plurality of images that are associated with each of the plurality of training text segments. Further, the plurality of training confidence scores can indicate a probability that each of the plurality of training text segments is accurate.

In some embodiments, the plurality of training text segments can comprise one or more training text segments that were labelled accurately. Further, the plurality of training text segments can comprise one or more accurate training text segments that were labelled inaccurately. For example, an image may comprise a sign with an unconventional spelling of a word that could be interpreted as a typographical error (e.g., “DELUX PIZZA” or “TASTEE EATERY”). The machine-learned model may be configured and/or trained to generate name attributes that include the unconventional spelling of the text segments (e.g., “DELUX PIZZA” instead of “DELUXE PIZZA”) without necessarily determining that the text segment comprises a typographical error and/or was inaccurately recognized or detected.

The systems, methods, devices, and/or computer-readable media (e.g., tangible non-transitory computer-readable media) in the disclosed technology can provide a variety of technical effects and benefits including an improvement in the effectiveness with which text in images is detected and/or recognized. Further, improved text detection and/or recognition can assist a user by providing more accurate search results when searching for information based on optical character recognized text. For example, the disclosed technology can assist the user in performing the technical task of retrieving information from a database (e.g., a map database) by improving the accuracy of search results presented to the user. The disclosed technology can also improve the effectiveness with which computational resources are used by leveraging a machine-learned model that is able to determine attributes of images more efficiently. The machine-learned model in the disclosed technology can use a novel transformer (e.g., joined transformer) configuration that is able to detect and recognize text with a high level of accuracy, which can reduce the use of excess computational resources to correct and/or modify incorrectly recognized text.

Additionally, the disclosed technology can automatically update map data and/or automatically generate map data. For example, map data that comprises previously stored attributes can be automatically updated such that the previously stored attributes associated with various locations are replaced with up-to-date attributes that were automatically generated using the disclosed technology. Further, map data comprising automatically generated attributes can be automatically generated for geographic locations that were not previously associated with attributes. In this way, the time consuming task of manually associating attributes with locations can be automatically performed by the disclosed technology.

As such, the disclosed technology can allow the user of a computing system to perform the technical task of detecting and recognizing text to determine attributes of images more accurately and effectively. As a result, users can be provided with the specific benefits of improved performance and more efficient use of system resources. Further, any of the specific benefits provided to users can be used to improve the effectiveness of a wide variety of devices and services including devices that use attributes based on recognized text. Accordingly, the improvements offered by the disclosed technology can result in tangible benefits to a variety of devices and/or systems including mechanical, electronic, and computing systems associated with determining attributes of images.

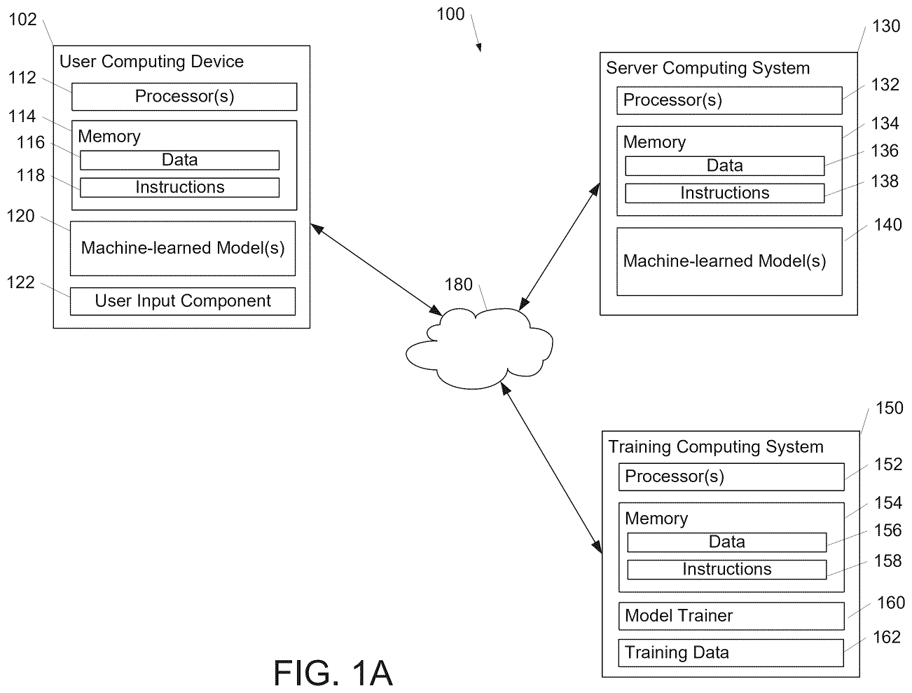

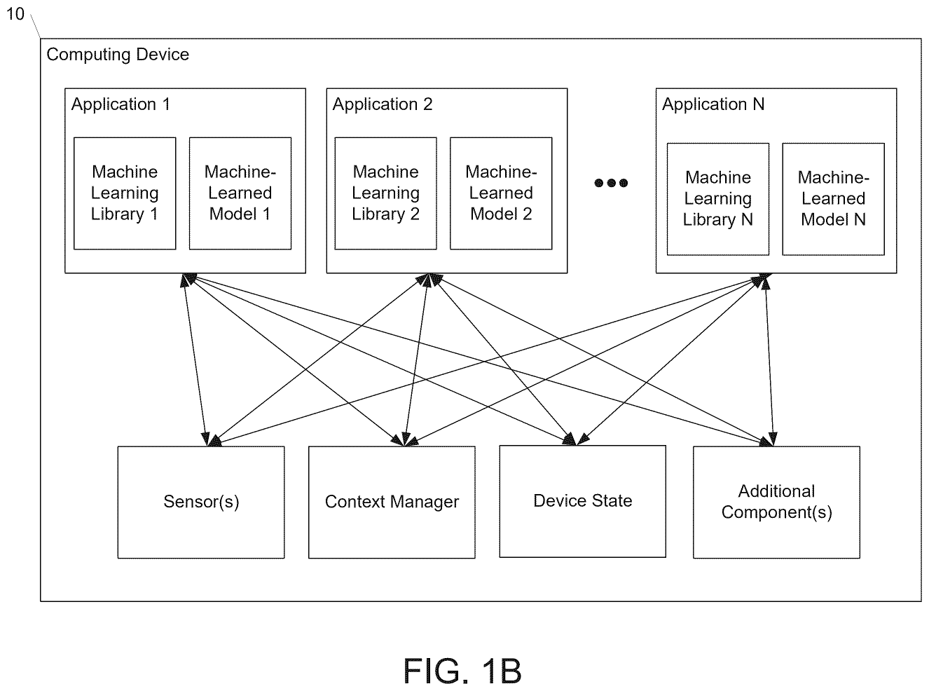

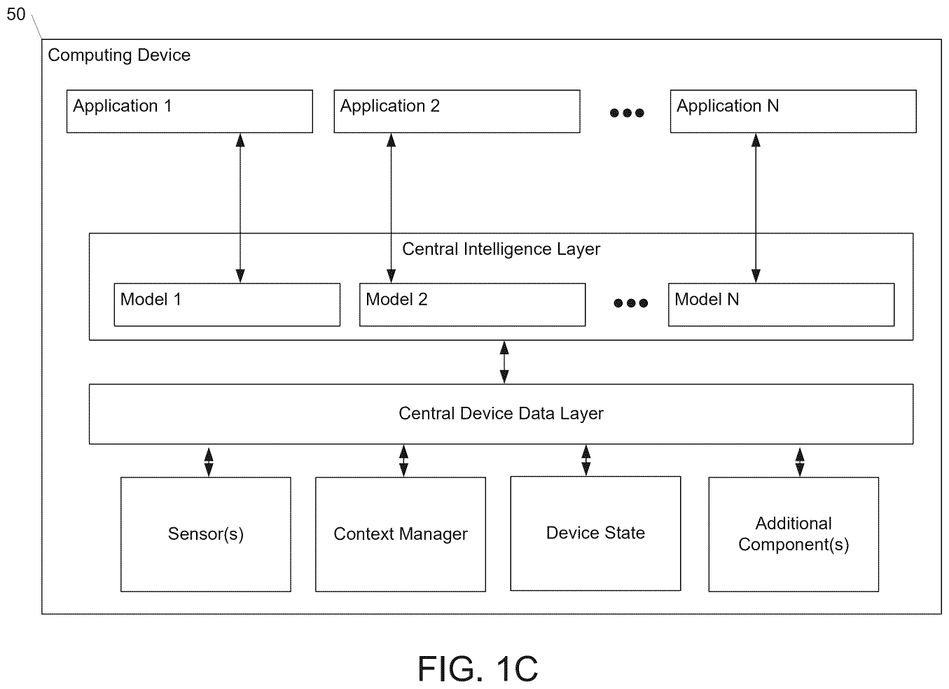

With reference now to the figures, example embodiments of the present disclosure will be discussed in further detail. FIG. 1A depicts a block diagram of an example of a computing system that processes images according to example embodiments of the present disclosure. System 100 includes a computing device 102, a server computing system 130, and a training computing system 150 that are communicatively coupled over a network 180.

The computing device 102 can comprise any type of computing device, including, for example, a personal computing device (e.g., laptop computing device or desktop computing device), a mobile computing device (e.g., smartphone or tablet), a gaming console or controller, an embedded computing device, a wearable computing device (e.g., a smartwatch), or any other type of computing device.

The computing device 102 includes one or more processors 112 and a memory 114. The one or more processors 112 can be any suitable processing device (e.g., a processor core, a microprocessor, an ASIC, an FPGA, a controller, and/or a microcontroller) and can be one processor or a plurality of processors that are operatively connected. The memory 114 can include one or more non-transitory computer-readable storage media, such as RAM, ROM, EEPROM, EPROM, flash memory devices, magnetic disks, and/or combinations thereof. The memory 114 can store data 116 and instructions 118 which are executed by the processor 112 to cause the computing device 102 to perform operations.

In some implementations, the computing device 102 can store or include one or more machine-learned models 120. For example, the one or more machine-learned models 120 can be or can otherwise include various machine-learned models such as neural networks (e.g., deep neural networks) or other types of machine-learned models, comprising non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Examples of one or more machine-learned models 120 are discussed with reference to FIGS. 1-9.

In some implementations, the one or more machine-learned models 120 can be received from the server computing system 130 over network 180, stored in the memory 114, and then used or otherwise implemented by the one or more processors 112. In some implementations, the computing device 102 can implement multiple parallel instances of a single machine-learned model of the one or more machine-learned models 120 (e.g., to perform parallel attribute generation operations across multiple instances of the one or more machine-learned models 120).

More particularly, the one or more machine-learned models 120 can comprise one or more machine-learned models (e.g., one or more LLMs) that are configured and/or trained to receive image data comprising images, determine, based on inputting the images into a machine-learned model, attributes of the images, determine entities associated with attributes, and/or generate attribute data comprising the attributes associated with the entities.

Additionally or alternatively, one or more machine-learned models 140 can be included in or otherwise stored and implemented by the server computing system 130 that communicates with the computing device 102 according to a client-server relationship. For example, the one or more machine-learned models 140 can be implemented by the server computing system 130 as a portion of a web service (e.g., an image data processing service and/or an attribute generation service). Thus, one or more machine-learned models 120 can be stored and implemented at the computing device 102 and/or one or more machine-learned models 140 can be stored and implemented at the server computing system 130.

The computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, and/or a microcontroller) and can be one processor or a plurality of processors that are operatively connected. The memory 134 can include one or more non-transitory computer-readable storage media, such as RAM, ROM, EEPROM, EPROM, flash memory devices, magnetic disks, and/or combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the one or more machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Examples of one or more machine-learned models 140 are discussed with reference to FIGS. 1-9.

The computing device 102 and/or the server computing system 130 can train the one or more machine-learned models 120 and/or the one or more machine-learned models 140 via interaction with the training computing system 150 that can be communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, and/or a microcontroller) and can be one processor or a plurality of processors that are operatively connected. The memory 154 can include one or more non-transitory computer-readable storage media, such as RAM, ROM, EEPROM, EPROM, flash memory devices, magnetic disks, and/or combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the one or more machine-learned models 120 and/or the one or more machine-learned models 140 stored at the computing device 102 and/or the server computing system 130 using various training or learning techniques (e.g., machine-learning techniques), such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a plurality of training iterations.

In some implementations, performing backwards propagation of errors can include performing truncated backpropagation through time. The model trainer 160 can perform a number of generalization techniques (e.g., weight decays, dropouts, and/or other generalization techniques.) to improve the generalization capability of the models being trained.

In particular, the model trainer 160 can train the one or more machine-learned models 120 and/or the one or more machine-learned models 140 based on a set of training data 162. The training data 162 can include various types of data. For example, the training data 162 can include image data, attribute data, and/or other data that is associated with the detection and/or recognition of images and the generation of attributes. For example, the training data 162 can comprise a plurality of images of various regions including buildings with signage. The training data 162 can also comprise ground-truth attributes that indicate the attributes of the plurality of images. Further, the training data 162 can include various publications (e.g., books, articles, and/or journals) that can be received from a variety of sources including libraries, the Internet (e.g., websites), and/or devices that can comprise sensors and can be configured to generate and/or receive data (e.g., smartwatches, smartphones, and/or other computing devices that can be configured to receive sensor data and/or data entered by a user). The model trainer 160 can train and/or retrain the one or more machine-learned models 120 and/or the one or more machine-learned models 140 based on additional data from the training data 162 which can comprise additional image data (e.g., updated image data), new types of image data (e.g., new types of image data based on sensor data from new sensor types), and/or one or more modifications to existing image data.

In some implementations, if a user has provided consent (e.g., the user provides affirmative consent for another party to use the user's image data), the training examples can be provided by the computing device 102. Thus, in such implementations, the one or more machine-learned models 120 provided to the computing device 102 can be trained by the training computing system 150 on user-specific data received from the computing device 102. In some instances, this process can be referred to as personalizing the model.

The model trainer 160 includes computer logic utilized to provide desired functionality. The model trainer 160 can be implemented in hardware, firmware, and/or software controlling a general-purpose processor. For example, in some implementations, the model trainer 160 includes program files stored on a storage device, loaded into a memory, and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases. In some implementations, the input to the machine-learned model(s) of the present disclosure can be text or natural language data. The machine-learned model(s) can process the text or natural language data to generate an output (e.g., based on inputting queries from a user the machine-learned model(s) can process and generate an analysis comprising one or more explanations and visualizations associated with the queries and image data of the user). As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can comprise speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can comprise latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can comprise statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can comprise sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio data or visual data).

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the computing device 102 can include the model trainer 160 and the training data 162. In such implementations, the one or more machine-learned models 120 can be both trained and used locally at the computing device 102. In some of such implementations, the computing device 102 can implement the model trainer 160 to personalize the one or more machine-learned models 120 based on user-specific data.

FIG. 1B depicts a block diagram of an example of a computing device that processes images according to example embodiments of the present disclosure. A computing device 10 can be a user computing device or a server computing device.

The computing device 10 can include a number of applications (e.g., applications 1 through N). Each application contains its own machine-learned library and machine-learned model(s). For example, each application can include a machine-learned model. Example applications include an image data processing application, attribute generation application, a text messaging application, an email application, a dictation application, a virtual keyboard application, and/or a browser application.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device that processes images and/or generates attributes according to example embodiments of the present disclosure. A computing device 50 can be a user computing device or a server computing device.

The computing device 50 includes a number of applications (e.g., applications 1 through N). Each application is in communication with a central intelligence layer. Example applications include an image processing application (e.g., an application that is used to process image data and generate attributes of images in the image data), a text messaging application, an email application, a dictation application, a virtual keyboard application, and/or a browser application. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

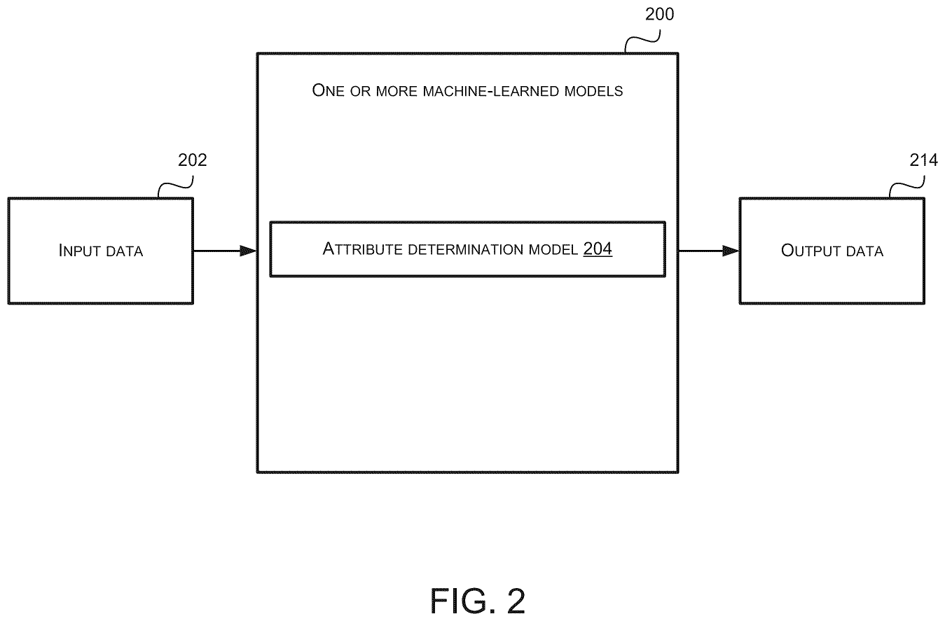

FIG. 2 depicts a block diagram of examples of machine-learned models according to example embodiments of the present disclosure. In some implementations, the one or more machine-learned models 200 can be trained to receive input data 202 that can comprise a plurality of images (e.g., images of geographic locations). As a result of receipt of the input data 202 the one or more machine-learned models 200 can generate output data 214 that can comprise a plurality of attributes based on classification of one or more text segments detected in the plurality of images.

In some implementations, the one or more machine-learned models 200 can include an attribute determination model 204 that is operable to determine a plurality of attributes associated with a business entity based on the analysis and/or evaluation of the plurality of images.

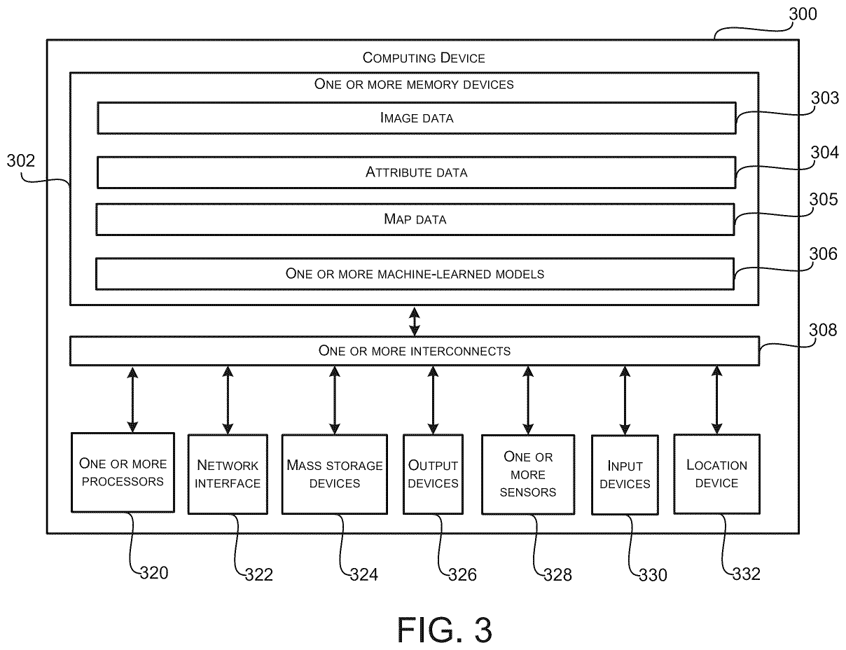

FIG. 3 depicts an example of a computing device according to example embodiments of the present disclosure. A computing device 300 can include one or more features and/or capabilities of the computing device 102, the server computing system 130, and/or the training computing system 150. Furthermore, the computing device 300 can perform one or more actions and/or operations performed by the computing device 102, the server computing system 130, and/or the training computing system 150, which are described with respect to FIG. 1A.

As shown in FIG. 3, the computing device 300 can include one or more memory devices 302, image data 303, attribute data 304, map data 305, one or more machine-learned models 306, one or more interconnects 308, one or more processors 320, a network interface 322, one or more mass storage devices 324, one or more output devices 326, one or more sensors 328, one or more input devices 330, and/or the location device 332. The computing device 300 can be configured as a desktop computing device and/or a mobile computing device (e.g., a smartphone, tablet computing device, and/or laptop computing device). Further, the computing device 300 can process and/or generate data (e.g., image data) based on a plurality of images detected by the one or more sensors 328 of the computing device 300) and/or data that is received from another computing device (e.g., image data that is generated by a remote computing device).

The one or more memory devices 302 can store information and/or data (e.g., the image data 303, the attribute data 304, the map data 305, and/or the one or more machine-learned models 306). Further, the one or more memory devices 302 can include one or more computer-readable mediums (e.g., tangible non-transitory computer-readable media), including RAM, ROM, EEPROM, EPROM, flash memory devices, magnetic disks, and combinations thereof. The information and/or data stored by the one or more memory devices 302 can be executed by the one or more processors 320 to cause the computing device 300 to perform operations including operations associated with receiving image data comprising images, determining, based on inputting the images into a machine-learned model, attributes of the images, determining entities associated with attributes, and/or generating attribute data comprising the attributes associated with the entities.

The image data 303 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the image data 303 can include information associated with a plurality of images (e.g., images of geographic locations). In some embodiments, the image data 303 can be received from one or more computing systems (e.g., the server computing system 130 that is depicted in FIG. 1) which can include one or more computing systems that are remote (e.g., in another building) from the computing device 300.

The attribute data 304 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the attribute data 304 can include information associated with a plurality of attributes of the plurality of images in the image data 303. In some embodiments, the attribute data 304 can be received from one or more computing systems (e.g., the server computing system 130 that is depicted in FIG. 1) which can include one or more computing systems that are remote from the computing device 300.

The map data 305 can include one or more portions of data (e.g., the data 116, the data 136, and/or the data 156, which are depicted in FIG. 1A) and/or instructions (e.g., the instructions 118, the instructions 138, and/or the instructions 158 which are depicted in FIG. 1A) that are stored in the memory 114, the memory 134, and/or the memory 154, respectively. Furthermore, the map data 305 can include information associated with one or more geographic locations that can be associated with the attribute data 304. The map data 305 can comprise coordinates (e.g., latitude, longitude, and/or altitude) that can be associated with the one or more geographic locations. Further, the map data 305 can comprise historical information about the one or more geographic locations. The map data 305 can be modified (e.g., historical information can be replaced with up-to-date information or new information can be added to historical information). In some embodiments, the map data 305 can be received from one or more computing systems (e.g., the server computing system 130 that is depicted in FIG. 1) which can include one or more computing systems that are remote from the computing device 300.

The one or more machine-learned models 306 (e.g., the one or more machine-learned models 120, the one or more machine-learned models 140, and/or the machine-learned models 200) can include one or more portions of the data 116, the data 136, and/or the data 156 which are depicted in FIG. 1A and/or instructions (e.g., the instructions 118, the instructions 138, and/or the instructions 158 which are depicted in FIG. 1A) that are stored in the memory 114, the memory 134, and/or the memory 154, respectively. Furthermore, the one or more machine-learned models 306 can include information associated with receiving image data comprising images, determining, based on inputting the images into a machine-learned model, attributes of the images, determining entities associated with attributes, and/or generating attribute data comprising the attributes associated with the entities. In some embodiments, the one or more machine-learned models 306 can be received from one or more computing systems (e.g., the server computing system 130 that is depicted in FIG. 1) which can include one or more computing systems that are remote from the computing device 300.

The one or more interconnects 308 can include one or more interconnects or buses that can be used to send and/or receive one or more signals (e.g., electronic signals) and/or data (e.g., the image data 303, the attribute data 304, the map data 305, and/or the one or more machine-learned models 306) between devices of the computing device 300, including the one or more memory devices 302, the one or more processors 320, the network interface 322, the one or more mass storage devices 324, the one or more output devices 326, the one or more sensors 328, and/or the one or more input devices 330. The one or more interconnects 308 can be arranged or configured in different ways, including as parallel or serial connections. Further the one or more interconnects 308 can include one or more internal buses to connect the internal components of the computing device 300; and one or more external buses used to connect the internal components of the computing device 300 to one or more external devices. By way of example, the one or more interconnects 308 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (Fire Wire), and/or other interfaces that can be used to connect components.

The one or more processors 320 can include one or more computer processors that are configured to execute the one or more instructions stored in the one or more memory devices 302. For example, the one or more processors 320 can, for example, include one or more general purpose central processing units (CPUs), application specific integrated circuits (ASICs), neural processing units (NPUs), and/or one or more graphics processing units (GPUs). Further, the one or more processors 320 can perform one or more actions and/or operations including one or more actions and/or operations associated with the image data 303, the attribute data 304, the map data 305, and/or the one or more machine-learned models 306. The one or more processors 320 can include single or multiple core devices including a microprocessor, microcontroller, integrated circuit, and/or a logic device.

The network interface 322 can support network communications. For example, the network interface 322 can support communication via networks including a local area network and/or a wide area network (e.g., the Internet). Further, the network interface 322 can be used to receive data (e.g., image data) from other computing devices. The one or more mass storage devices 324 (e.g., a hard disk drive and/or a solid-state drive) can be used to store data including the attribute data 304 and/or the one or more machine-learned models 306.

The one or more output devices 326 can include one or more display devices (e.g., LCD display, OLED display, Mini-LED display, microLED display, plasma display, and/or CRT display), one or more light sources (e.g., LEDs), one or more audio output devices (e.g., one or more loudspeakers), and/or one or more haptic output devices (e.g., one or more devices that are configured to generate vibratory output). For example, the one or more output devices 326 can comprise a touch sensitive display that is used to output an interface (e.g., a user interface) that can be configured to display indications based on images associated with the image data 303 and attributes of the attribute data 304 that is associated with the image data 303.

The one or more sensors 328 can comprise one or more LiDAR devices, one or more sonar devices, one or more radar devices, one or more accelerometers, one or more gyroscopes, one or more altimeters, and/or one or more temperature sensors (e.g., one or more thermometers). The one or more input devices 330 can include one or more keyboards, one or more touch sensitive devices (e.g., a touch screen display), one or more buttons (e.g., a power button and/or volume buttons), one or more microphones, and/or one or more imaging devices (e.g., one or more cameras).

The one or more memory devices 302 and the one or more mass storage devices 324 are illustrated separately, however, the one or more memory devices 302 and the one or more mass storage devices 324 can be regions within the same memory module. The computing device 300 can include one or more additional processors, memory devices, network interfaces, which may be provided separately or on the same chip or board. The one or more memory devices 302 and the one or more mass storage devices 324 can include one or more computer-readable media, including, but not limited to, non-transitory computer-readable media, RAM, ROM, hard drives, flash drives, and/or other memory devices.

The one or more memory devices 302 can store sets of instructions for applications including an operating system that can be associated with various software applications or data. For example, the one or more memory devices 302 can store sets of instructions for applications that can generate output including one or more attributes associated with images. The one or more memory devices 302 can be used to operate various applications including a mobile operating system developed specifically for mobile devices. As such, the one or more memory devices 302 can store instructions that allow the software applications to access data including data associated with the generation of attributes associated with image data. In other embodiments, the one or more memory devices 302 can be used to operate or execute a general-purpose operating system that operates on both mobile and stationary devices, including for example, smartphones, laptop computing devices, tablet computing devices, and/or desktop computers.

The software applications that can be operated or executed by the computing device 300 can include applications associated with the system 100 shown in FIG. 1A. Further, the software applications that can be operated and/or executed by the computing device 300 can include native applications and/or web-based applications.

The location device 332 can include one or more devices or circuitry for determining the position of the computing device 300. For example, the location device 332 can determine an actual and/or relative position of the computing device 300 by using a satellite navigation positioning system (e.g., a GPS system, a Galileo positioning system, the GLObal Navigation satellite system (GLONASS), and/or the BeiDou Satellite Navigation and Positioning system), an inertial navigation system, a dead reckoning system, based on IP address, by using triangulation and/or proximity to cellular towers and/or Wi-Fi hotspots.

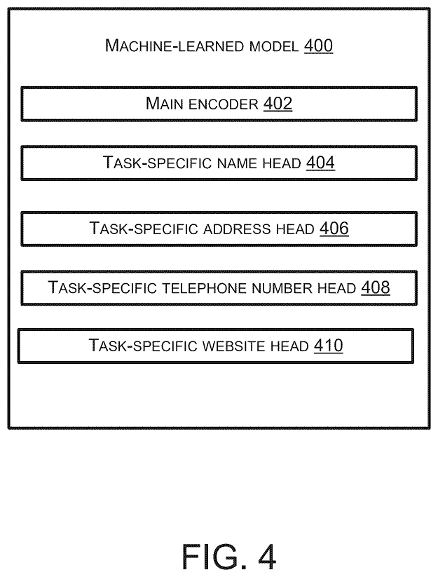

FIG. 4 depicts an example of a machine-learned model according to example embodiments of the present disclosure. The machine-learned model 400 can be implemented by a computing device that has one or more features and/or capabilities of the computing device 102, the server computing system 130, the training computing system 150, and/or the computing device 300.

In this example, the machine-learned model 400 can comprise a main encoder 402, a task-specific name head 404, a task-specific address head 406, a task-specific telephone number head 408, or a task-specific website head 410. The machine-learned model 400 can comprise a multitask model that can be concurrently configured and/or trained to perform a plurality of tasks (e.g., image detection, recognition, and/or classification tasks performed on images). For example, the machine-learned model can be configured and/or trained to generate a plurality of attributes based on input comprising image data comprising a plurality of images. In some embodiments, the machine-learned model 400 can comprise a transformer model (e.g., a joined transformer model) that can be configured and/or trained to generate and/or determine a plurality of attributes based on input comprising a plurality of images. Further, in some embodiments, the main encoder 402 can comprise a joined encoder.

The main encoder 402 can be configured and/or trained to generate a plurality of embeddings (e.g., a plurality of multimodal embeddings) based on a plurality of multimodal inputs comprising the plurality of images, the one or more text segments, one or more detection boxes associated with the one or more text segments, and/or one or more confidence scores associated with the one or more text segments. The plurality of multimodal inputs can be based on object detection, object recognition, text segment detection, text segment recognition, detection box generation, and/or confidence score generation associated with a plurality of images. The machine-learned model 400 can comprise a task-specific name head 404 that is configured and/or trained to generate and/or determine a plurality of attributes associated with the name of an entity detected in an image. For example, the task-specific name head 404 can generate and/or determine a name attribute comprising the name of a business shown in an image.

Further, the machine-learned model 400 can comprise a task-specific address head 406 that is configured and/or trained to generate and/or determine a plurality of attributes associated with the address of an entity detected in an image. For example, the task-specific address head 406 can generate and/or determine an address attribute comprising the street address of a business entity shown in an image.

The machine-learned model 400 can comprise a task-specific telephone number head 408 that is configured and/or trained to generate and/or determine a plurality of attributes associated with the telephone number of an entity detected in an image. For example, the task-specific telephone number head 408 can generate and/or determine a seven-digit and/or ten-digit telephone number attribute comprising the telephone number of a business entity shown in an image.

Further, the machine-learned model 400 can comprise a task-specific website head 410 that is configured and/or trained to generate and/or determine a plurality of attributes associated with the website of an entity detected in an image. For example, the task-specific website head 410 can generate and/or determine a website attribute comprising the web address of a website of a business entity shown in an image.

In some embodiments, the machine-learned model 400 can be configured and/or trained to generate and/or determine a plurality of additional attributes that are different from the attributes for which the machine-learned model is configured and/or trained. The machine-learned model 400 can add additional task-specific heads to generate and/or determine the additional attributes. For example, additional task-specific heads can be added to the machine-learned model 400 and the additional task-specific heads can be configured and/or trained to generate and/or determine additional attributes associated with an operational status and/or service options associated with an entity. Configuring and/or training the machine-learned model 400 can comprise modifying and/or updating a plurality of weights associated with a plurality of parameters of the main encoder. Further, configuring and/or training the machine-learned model 400 can comprise modifying and/or updating a plurality of weights associated with a plurality of parameters of and the additional task-specific head that generates and/or determines the additional attributes.

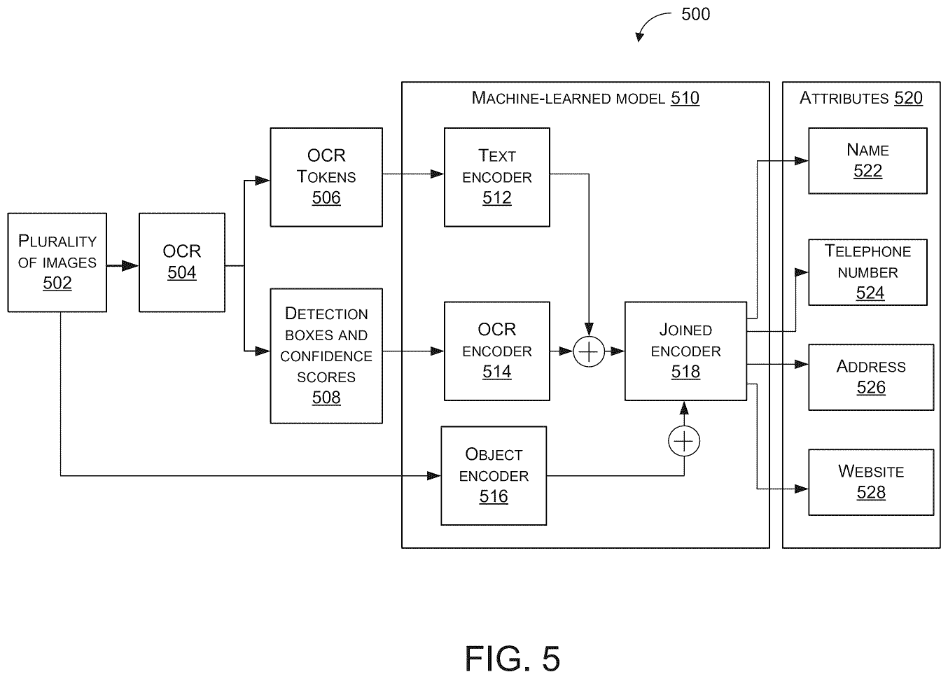

FIG. 5 depicts an example of a computing system that generates attributes associated with images according to example embodiments of the present disclosure. A computing system 500 can include one or more features and/or capabilities of the computing device 102, the server computing system 130, the training computing system 150, and/or the computing device 300. Furthermore, the computing system 500 can perform one or more actions and/or operations that can be performed by the computing device 102, the server computing system 130, the training computing system 150, and/or the computing device 300.

As shown in FIG. 5, the computing system 500 comprises a plurality of images 502, an optical character recognition (OCR) device 504, OCR tokens 506, detection boxes and confidence scores 508, a machine-learned model 510, a text encoder 512, an OCR encoder 514, an object encoder 516, a joined encoder 518, a plurality of attributes 520, a name attribute 522, a telephone number attribute 524, an address attribute 526, or a website attribute 528.

The plurality of images 502 can be inputted into the OCR device 504. The OCR device 504 can be configured and/or trained to generate the plurality of OCR tokens 506 (e.g., one or more text segments which can comprise words and/or sentences detected and/or recognized in the plurality of images 502). In some embodiments, the OCR device 504 can implement one or more machine-learned models that are configured and/or trained to generate output (e.g., OCR tokens) based on the plurality of images 502. Further, the OCR device 504 can generate the detection boxes and confidence scores 508 which can comprise the detection boxes of the one or more text segments detected in the plurality of images 502 and/or confidence scores that indicate the accuracy of the detection boxes.

The machine-learned model 510 can be configured and/or trained to generate the plurality of attributes 520. Further, the machine-learned model 510 can comprise the text encoder 512, the OCR encoder 514, the object encoder 516, and/or the joined encoder 518. The OCR tokens 506 can be inputted into the text encoder 512 that can be part of the machine-learned model 510 and can generate a plurality of text embeddings that can be inputted into the joined encoder 518. In some embodiments, the text encoder 512 can comprise one or more machine-learned models that are configured and/or trained to generate output (e.g., the plurality of text embeddings) based on the OCR tokens 506.

The detection boxes and confidence scores 508 can be inputted into the OCR encoder 514 that can be part of the machine-learned model 510 and can generate a plurality of OCR embeddings that can be inputted into the joined encoder 518. In some embodiments, the OCR encoder 514 can comprise one or more machine-learned models that are configured and/or trained to generate output (e.g., the plurality of OCR embeddings) based on the detection boxes and confidence scores 508.

Further, the plurality of images 502 can be inputted into the object encoder 516 that can be part of the machine-learned model 510 and can generate a plurality of image embeddings that can be inputted into the joined encoder 518. The object encoder 516 can comprise one or more machine-learned models that are configured and/or trained to generate output (e.g., the plurality of image embeddings) based on the plurality of images 502. In some embodiments, the object encoder 516 can comprise a self-supervised learning (SSL) model. In some embodiments, token-level sum operations can be performed on the plurality of text embeddings, the plurality of OCR embeddings, and/or the plurality of image embeddings.

The joined encoder 518 can be part of the machine-learned model 510 and can be configured and/or trained to generate and/or determine the plurality of attributes 520. In some embodiments, the joined encoder 518 can comprise a plurality of task-specific heads that can be configured and/or trained to generate and/or determine the plurality of attributes 520. The joined encoder 518 can comprise one or more machine-learned models that are configured and/or trained to generate output (e.g., the plurality of attributes) based on input comprising the plurality of text embeddings, the plurality of OCR embeddings, and/or the plurality of image embeddings. In this example, the plurality of attributes 520 can comprise a name attribute 522, a telephone number attribute 524, an address attribute 526, and/or a website attribute 528. The plurality of attributes 520 can be used in a variety of applications. For example, the plurality of attributes can be used in applications comprising map applications and/or navigation applications.

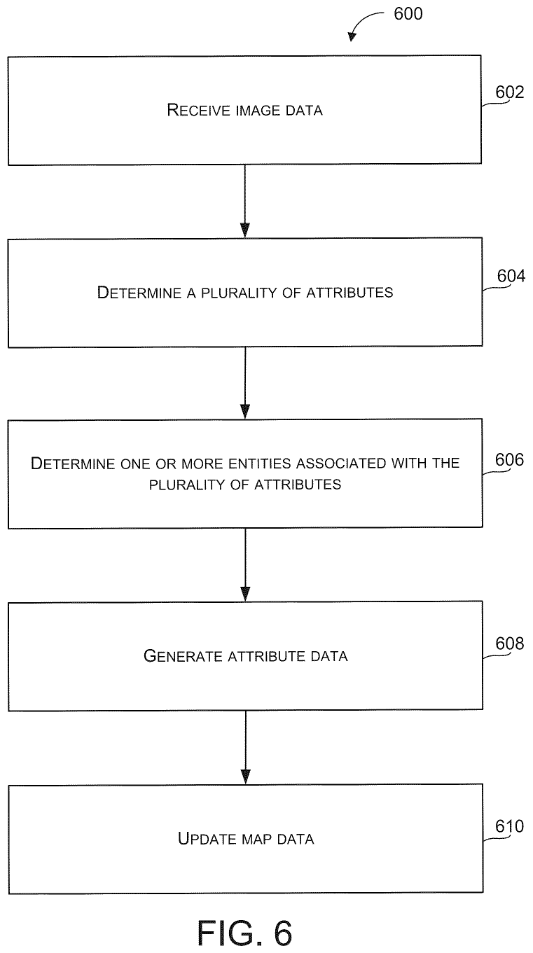

FIG. 6 depicts a flow chart diagram of an example method of processing images according to example embodiments of the present disclosure. One or more portions of the method 600 can be executed and/or implemented on one or more computing devices or computing systems comprising, for example, the computing device 102, the server computing system 130, the training computing system 150, and/or the computing device 300. Further, one or more portions of the method 600 can be executed or implemented as an algorithm on the hardware devices or systems disclosed herein. FIG. 6 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 602, the method 600 can include receiving image data comprising a plurality of images. For example, the server computing system 130 can receive image data comprising a plurality of images of buildings (e.g., the front of buildings). The image data can be received from a local device and/or via a network such as the network 180.

At 604, the method 600 can include generating and/or determining, based on inputting the plurality of images into a machine-learned model, a plurality of attributes associated with the plurality of images and/or one or more entities. The machine-learned model can be configured and/or trained to recognize one or more text segments in the plurality of images. In some embodiments, the plurality of attributes can be based on the one or more text segments associated with one or more entities. For example, the server computing system 130 can determine a plurality of attributes comprising a name, telephone number, category (e.g., type of business), and/or website associated with an entity (e.g., a non-profit organization) detected in the plurality of images.

At 606, the method 600 can include determining one or more entities associated with the plurality of attributes. For example, the server computing system 130 can determine one or more entities associated with the plurality of attributes that were determined. For example, the one or more entities can comprise a business entity that may have a name that matches a name attribute and/or website attribute that was determined. In some embodiments, the one or more entities associated with the plurality of attributes can be determined based on an entity attribute determined by the machine-learned model.

At 608, the method 600 can include generating attribute data comprising the plurality of attributes associated with the one or more entities. For example, the server computing system 130 can generate attribute data comprising a plurality of attributes associated with a name, address, and/or website associated with an entity (e.g., a business).

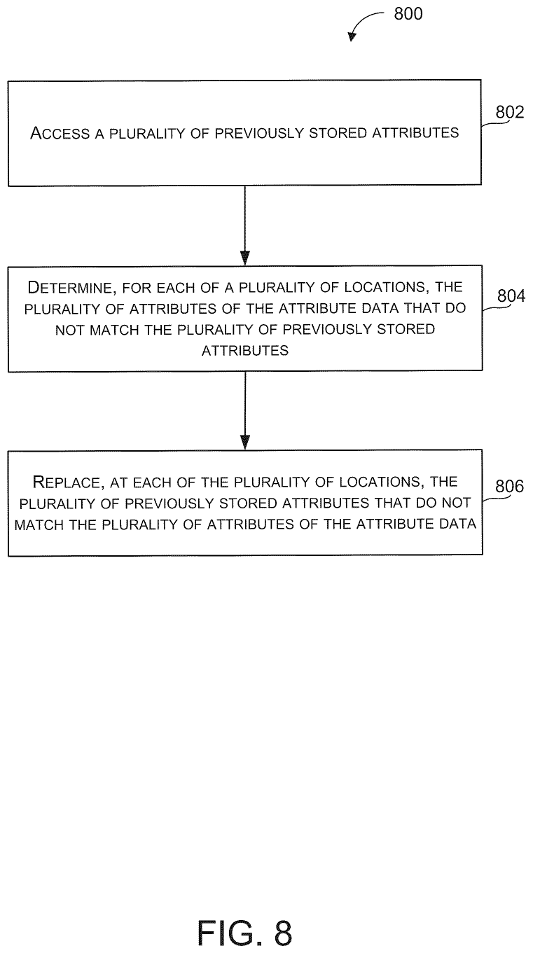

At 610, the method 600 can include updating, based on the attribute data, map data associated with a plurality of locations. For example, the server computing system 130 can access map data (e.g., map data stored on the server computing device 130 and/or a remote computing device), determine the previously stored attributes associated with the plurality of locations that do not match the plurality of attributes that were most recently generated (e.g., the plurality of attributes associated with the one or more entities), and replace the previously stored attributes that do not match with the most recently generated plurality of attributes. In some embodiments, updating the map data can comprise one or more portions of the method 800 that is described with respect to FIG. 8.

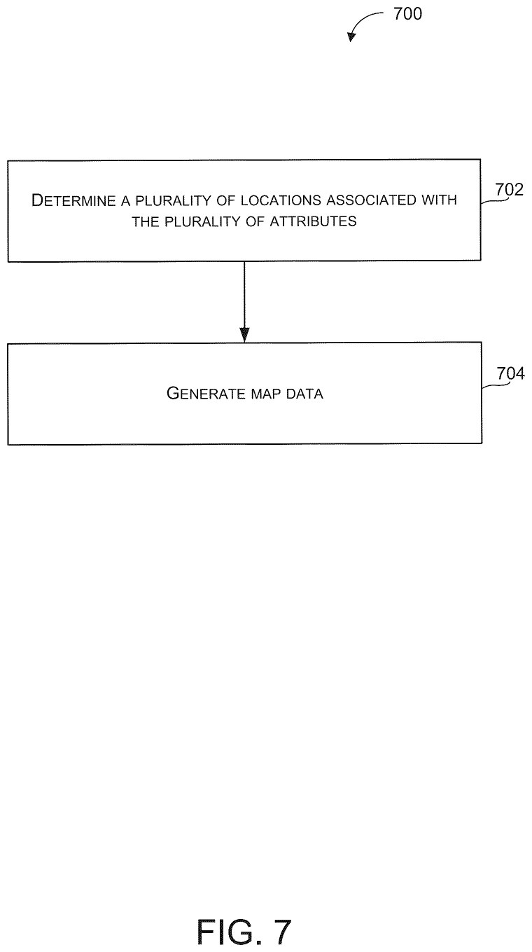

FIG. 7 depicts a flow chart diagram of an example method of generating map data based on a plurality of attributes according to example embodiments of the present disclosure. One or more portions of the method 700 can be executed and/or implemented on one or more computing devices or computing systems comprising, for example, the computing device 102, the server computing system 130, the training computing system 150, and/or the computing device 300. Further, one or more portions of the method 700 can be executed or implemented as an algorithm on the hardware devices or systems disclosed herein. In some embodiments, one or more portions of the method 700 can be performed as part of the method 600 that is described with respect to FIG. 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 702, the method 700 can include determining a plurality of locations associated with the plurality of attributes. For example, the server computing system 130 can determine a plurality of locations based on location data included in the plurality of images (e.g., location data comprising a latitude, longitude, and/or altitude) and/or the plurality of attributes associated with a location (e.g., a street sign or address written on a storefront).

At 704, the method 700 can include generating map data comprising the plurality of attributes and/or the plurality of locations associated with the plurality of attributes. For example, the server computing system 130 can generate map data comprising a plurality of attributes associated with a geographical location (e.g., latitude, longitude, and/or altitude). In some embodiments, the map data can comprise a street address based on a street address attribute.

FIG. 8 depicts a flow chart diagram of an example method of updating attributes according to example embodiments of the present disclosure. One or more portions of the method 800 can be executed and/or implemented on one or more computing devices or computing systems comprising, for example, the computing device 102, the server computing system 130, the training computing system 150, and/or the computing device 300. Further, one or more portions of the method 800 can be executed or implemented as an algorithm on the hardware devices or systems disclosed herein. In some embodiments, one or more portions of the method 800 can be performed as part of the method 600 that is described with respect to FIG. 6. FIG. 8 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 802, the method 800 can include accessing map data. The map data can comprise a plurality of previously stored attributes generated before the plurality of attributes of the attribute data (e.g., the plurality of attributes associated with the one or more entities). For example, the server computing system 130 can access map data comprising a plurality of previously stored attributes that comprise attributes (e.g., the name and telephone number of a business entity) that are associated with an entity (e.g., a business entity). In some embodiments, the plurality of stored attributes can be associated with a plurality of locations (e.g., geographic locations comprising addresses and/or geographic coordinates).

At 804, the method 800 can include determining for each of the plurality of locations, the plurality of attributes of the attribute data that do not match the plurality of previously stored attributes. The plurality of attributes of the attribute data that do not match the plurality of previously stored attributes can comprise the plurality of attributes with values (e.g., a telephone number attribute can have a ten-digit numerical value and/or a category attribute can comprise an alphanumeric value) that do not match the values of the plurality of previously stored attributes. For example, the server computing system 130 can compare the plurality of attributes of the attribute data to the plurality of previously stored attributes at each of the plurality of locations to determine the plurality of attributes of the attribute data that do not match the plurality of previously stored attributes. Further, the server computing system 130 can compare the plurality of attributes of the attribute data comprising the name and/or telephone number of an entity to the plurality of previously stored attributes comprising the name and/or telephone number of the entity to determine the plurality of attributes at the same location that do not match.

At 806, the method 800 can include, replacing, at each of the plurality of locations in which the plurality of attributes of the attribute data do not match the plurality of previously stored attributes, the plurality of previously stored attributes with the plurality of attributes of the attribute data. For example, the server computing system 130 can replace the plurality of previously stored attributes comprising a telephone number attribute that does not match the telephone number attribute of the plurality of (newer) attributes of the map data.

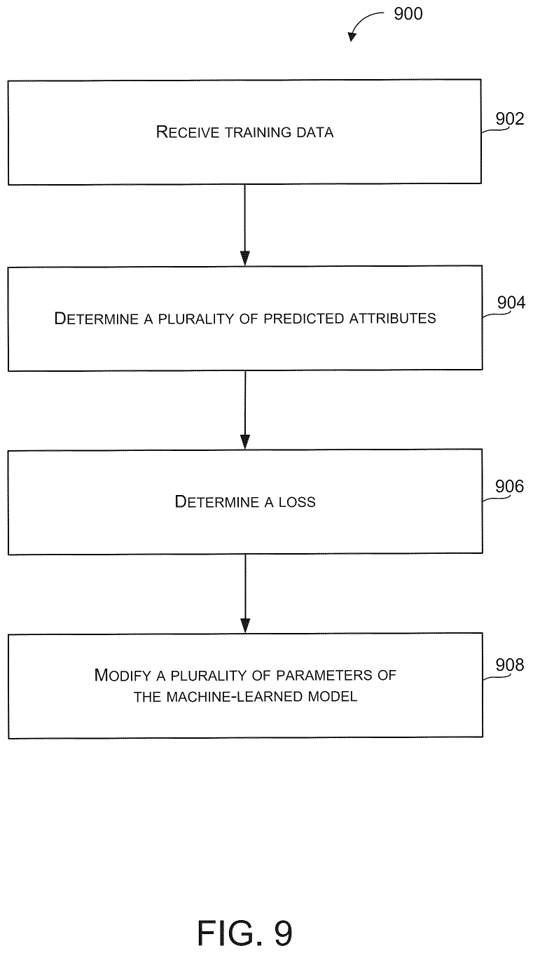

FIG. 9 depicts a flow chart diagram of an example method of training machine-learned models to process images according to example embodiments of the present disclosure. One or more portions of the method 900 can be executed and/or implemented on one or more computing devices or computing systems comprising, for example, the computing device 102, the server computing system 130, the training computing system 150, and/or the computing device 300. Further, one or more portions of the method 900 can be executed or implemented as an algorithm on the hardware devices or systems disclosed herein. In some embodiments, one or more portions of the method 900 can be performed as part of the method 600 that is described with respect to FIG. 6. FIG. 9 depicts steps performed in a particular order for purposes of illustration and discussion. Those of ordinary skill in the art, using the disclosures provided herein, will understand that various steps of any of the methods disclosed herein can be adapted, modified, rearranged, omitted, and/or expanded without deviating from the scope of the present disclosure.

At 902, the method 900 can include receiving training data comprising a plurality of training images and a corresponding plurality of ground-truth attributes. For example, the server computing system 130 can receive image data comprising a plurality of training images. The plurality of training images can comprise images of geographic areas comprising buildings with surfaces that comprise signage and/or other writing. The plurality of ground-truth attributes can indicate the actual attributes associated with each image of the plurality of images.

At 904, the method 900 can include determining, based on inputting the plurality of training images into the machine-learned model, a plurality of predicted attributes. For example, the server computing system 130 can implement a machine-learned model. Further, based on inputting the plurality of training images into the machine-learned model, the machine-learned model can perform one or more operations (e.g., detection and/or recognition operations) on the plurality of training images and generate an output comprising a plurality of predicted attributes.

At 906, the method 900 can include determining a loss based on one or more differences between the plurality of predicted attributes and the plurality of ground-truth attributes. For example, over a plurality of iterations, the server computing system 130 can determine a loss (e.g., a cross-entropy loss) based on one or more differences between the plurality of predicted attributes and the plurality of ground-truth attributes.

At 908, the method 900 can include modifying a plurality of parameters of the machine-learned model to minimize the loss. For example, the server computing system 130 can modify a plurality of weights of the plurality of parameters so that the weights of the plurality of parameters that contribute to reducing the loss (e.g., the parameters that increase the accuracy of the machine-learned model generating a plurality of predicted attributes that are accurate) are increased and/or the weights of the plurality of parameters that contribute to increasing the loss (e.g., the parameters that decrease the accuracy of the machine-learned model generating a plurality of predicted attributes that are accurate) are decreased. The plurality of weights of the plurality of parameters can be modified until some threshold loss (e.g., a minimized loss) that corresponds to a high accuracy of the plurality of predicted classification outputs is exceeded.

Further to the descriptions above, a user may be provided with controls allowing the user to make an election as to both if and/or when systems, programs, or features described herein may enable collection of user information (e.g., image information), and if the user is sent content or communications from a server. In addition, certain data may be treated in one or more ways before it is stored or used, so that certain information of a user may be removed. For example, a user's identity may be treated so that certain other information associated with the user's identity may not be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computer-implemented method of processing images, the computer-implemented method comprising:
receiving, by a computing system comprising one or more processors, image data comprising a plurality of images;
determining, by the computing system, based on inputting the image data into a machine-learned model configured to recognize one or more text segments detected in the plurality of images, a plurality of attributes associated with the plurality of images, wherein the machine-learned model comprises a plurality of task-specific heads configured to determine the plurality of attributes;
determining, by the computing system, one or more entities associated with the plurality of attributes;
generating, by the computing system, attribute data comprising the plurality of attributes associated with the one or more entities; and
updating, by the computing system, based on the attribute data, map data associated with a plurality of locations.

2. The computer-implemented method of claim 1, wherein the machine-learned model comprises a transformer that is configured to generate multimodal embeddings based on a plurality of multimodal inputs.

3. The computer-implemented method of claim 2, wherein the plurality of multimodal inputs comprise the plurality of images, the one or more text segments, one or more detection boxes associated with the one or more text segments, or one or more confidence scores associated with the one or more text segments.

4. The computer-implemented method of claim 1, wherein the machine-learned model comprises an object encoder that is configured to generate a plurality of image embeddings based on detecting or recognizing one or more objects in the plurality of images.

5. The computer-implemented method of claim 1, wherein the machine-learned model comprises a text encoder that is configured to generate a plurality of text embeddings based on detecting or recognizing the one or more text segments in the plurality of images.

6. The computer-implemented method of claim 1, wherein the machine-learned model comprises an optical character recognition (OCR) encoder that is configured to generate a plurality of OCR embeddings based on the one or more text segments.

7. The computer-implemented method of claim 1, wherein the plurality of attributes comprises a name associated with the one or more entities, a category associated with the one or more entities, a global category identifier (GCID) associated with the one or more entities, a telephone number associated with the one or more entities, a website associated with the one or more entities, an operational status associated with the one or more entities, or an address associated with the one or more entities.

8. The computer-implemented method of claim 1, wherein the machine-learned model is configured to determine the plurality of attributes concurrently.

9. The computer-implemented method of claim 1, wherein the machine-learned model is a multitask model comprising a main encoder and the plurality of task-specific heads, wherein the main encoder is configured to generate a plurality of embeddings based on the plurality of images, and wherein the plurality of task-specific heads are configured to determine the plurality of attributes based on the plurality of embeddings.

10. The computer-implemented method of claim 1, further comprising:
determining, by the computing system, the plurality of locations associated with the plurality of attributes; and
generating, by the computing system, the map data comprising the plurality of attributes and the plurality of locations associated with the plurality of attributes.

11. The computer-implemented method of claim 1, wherein the map data comprises a plurality of previously stored attributes associated with the plurality of locations and generated before the plurality of attributes of the attribute data, and wherein the updating, by the computing system, based on the attribute data, map data associated with a plurality of locations comprises:
accessing, by the computing system, the map data comprising the plurality of previously stored attributes associated with the plurality of locations and generated before the plurality of attributes of the attribute data;
determining, by the computing system, for each of the plurality of locations, the plurality of attributes of the attribute data that do not match the plurality of previously stored attributes; and
replacing, by the computing system, at each of the plurality of locations in which the plurality of attributes of the attribute data do not match the plurality of previously stored attributes, the plurality of previously stored attributes with the plurality of attributes of the attribute data.

12. The computer-implemented method of claim 1, wherein the plurality of images comprise images of buildings captured from a perspective that is substantially parallel to a ground plane of the plurality of images.

13. The computer-implemented method of claim 1, wherein the machine-learned model is trained to determine the plurality of attributes, and wherein the training the machine-learned model comprises:
receiving, by the computing system, training data comprising a plurality of training images and a corresponding plurality of ground-truth attributes;
determining, by the computing system, based on inputting the plurality of training images into the machine-learned model, a plurality of predicted attributes;
determining, by the computing system, a loss based on one or more differences between the plurality of predicted attributes and the corresponding plurality of ground-truth attributes; and
modifying, by the computing system, a plurality of parameters of the machine-learned model to minimize the loss.

14. The computer-implemented method of claim 13, wherein the training data comprises a plurality of training text segments based on optical character recognition performed on the plurality of training images, a plurality of detection boxes associated with each of the plurality of training text segments, or a plurality of confidence scores associated with each of the plurality of training text segments.

15. One or more tangible non-transitory computer-readable media storing computer-readable instructions that when executed by one or more processors cause the one or more processors to perform operations, the operations comprising:
receiving image data comprising a plurality of images;
determining, based on inputting the image data into a machine-learned model configured to recognize one or more text segments detected in the plurality of images, a plurality of attributes associated with the plurality of images, wherein the machine-learned model comprises a plurality of task-specific heads configured to determine the plurality of attributes;
determining one or more entities associated with the plurality of attributes;
generating attribute data comprising the plurality of attributes associated with the one or more entities; and
updating, based on the attribute data, map data associated with a plurality of locations.

16. The one or more tangible non-transitory computer-readable media of claim 15, wherein the machine-learned model comprises a transformer that is configured to generate multimodal embeddings based on a plurality of multimodal inputs.

17. The one or more tangible non-transitory computer-readable media of claim 15, wherein the machine-learned model is a multitask model comprising a main encoder and the plurality of task-specific heads, wherein the main encoder is configured to generate a plurality of embeddings based on the plurality of images, and wherein the plurality of task-specific heads are configured to determine the plurality of attributes based on the plurality of embeddings.

18. A computing system comprising:
one or more processors;
one or more non-transitory computer-readable media storing instructions that when executed by the one or more processors cause the one or more processors to perform operations comprising:
receiving image data comprising a plurality of images;
determining, based on inputting the image data into a machine-learned model configured to recognize one or more text segments detected in the plurality of images, a plurality of attributes associated with the plurality of images, wherein the machine-learned model comprises a plurality of task-specific heads configured to determine the plurality of attributes;
determining one or more entities associated with the plurality of attributes;
generating attribute data comprising the plurality of attributes associated with the one or more entities; and
updating, based on the attribute data, map data associated with a plurality of locations.

19. The computing system of claim 18, wherein the machine-learned model comprises a transformer that is configured to generate multimodal embeddings based on a plurality of multimodal inputs.

20. The computing system of claim 18, wherein the machine-learned model is a multitask model comprising a main encoder and the plurality of task-specific heads, wherein the main encoder is configured to generate a plurality of embeddings based on the plurality of images, and wherein the plurality of task-specific heads are configured to determine the plurality of attributes based on the plurality of embeddings.
